(19) United States
(12) Patent Application Publication
(10) Pub. No.: US 2006/0074663 A1
(43) Pub. Date: Apr. 6, 2006

(54) Speech waveform processing system and method

(75) Inventors: Xiao-Hui Shao, Taipei (TW); Chaucer Chiu, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/002,642

(22) Filed: Dec. 1, 2004

(30) Foreign Application Priority Data
Oct. 6, 2004 (TW) 093130195

(51) Int. Cl. G10L 15/04

(52) U.S. Cl. 704/254

(57) ABSTRACT

A speech waveform processing system and method which is able to perform a segmentation process for a continuous speech waveform according to predetermined speech parameters is proposed. First of all, an inputted continuous speech signal is read and subsequently preprocessed by the system. Meanwhile, the waveform of the speech signal is displayed. Then, the predetermined parameters for processing the speech waveform and inputted information relevant to the speech signal are stored by the system. Subsequently, a segmentation process is performed for the inputted continuous speech signal according to the predetermined parameters for processing the speech waveform and the inputted information relevant to the speech signal. Further, the waveform of the speech signal acquired after the segmentation process is displayed. Then, a segmentation index is established after segmentation for segments of the speech signal, such that any segment in the continuous speech waveform can be rapidly reached to increase the applications for the speech processing technique.

### FIELD OF THE INVENTION

The present invention relates to speech waveform processing systems and methods, and more particularly, to a speech waveform processing system and method that performs a segmentation process for a continuous speech waveform according to predetermined speech parameters.

### BACKGROUND OF THE INVENTION

Along with the blooming development of computer technology in nowadays society, computer industries have been identified as being of importance to men's daily life. Information processing using computers has progressed from processing of simple word files to processing of all forms of information such as audio and video data.

Among various information processing formats, research has highly focused on processing techniques of the audio information, for example, the technique of processing speech sound waves in combination with corresponding software to achieve different applications. Recently, a technique which is able to perform a segmentation process for speech waveforms has been disclosed, such that the segmentation process can be performed on the audio data to partition continuous speech signals into different units. However, such technique usually needs to be operated using a unified standard, and thus lacks automation and flexibility. Therefore, application fields of this technique are limited.

Furthermore, the segmentation processing technique for continuous speech known in the prior-art is simply considered as a theoretical technique that lacks practicability.

Thus, there is a need to provide an automatic and flexible speech waveform processing system and method which can be applied in many fields.

### SUMMARY OF THE INVENTION

In light of the above prior-art drawbacks, a primary objective of the present invention is to provide a speech waveform processing system and method capable of partitioning a continuous speech waveform into a plurality of segments according to predetermined speech parameters.

Another objective of the present invention is to provide a speech waveform processing system and method which can establish an index mechanism based on segments produced by a segmentation process.

Still another objective of the present invention is to provide a speech waveform processing system and method, by which any segments in continuous speech can be rapidly reached.

A further objective of the present invention is to provide a speech waveform processing system and method which can establish a connection between any segment and other media signal using an index mechanism.

In accordance with the above and other objectives, the present invention proposes a speech waveform processing system and method.

The speech waveform processing system proposed in the present invention comprises (1) a speech data preprocessing module for reading a continuous speech signal and preprocessing the speech signal; (2) a storage module for storing predetermined parameters for processing the speech waveform and information relevant to the inputted speech signals; (3) a segmentation processing module for performing a segmentation process on the inputted continuous speech signal according to the predetermined parameters for processing the speech waveform and the information relevant to the inputted speech signals; (4) a segmentation result displaying module for providing users with segmentation index acquired from the segmentation process performed by the segmentation processing module; and (5) a waveform displaying module for displaying the waveform of the inputted continuous speech signal and the waveform of the speech signal acquired from the segmentation process performed by the segmentation processing module.

The present invention also proposes a speech waveform processing method using the foregoing speech waveform processing system. Firstly, the inputted continuous speech signal is read and subsequently preprocessed by the speech data preprocessing module. The waveform of the inputted continuous speech signal is displayed to the user by the waveform displaying module. Then, predetermined parameters for processing the speech waveform and the information relevant to inputted speech signal are stored in the storage module. A segmentation process for the inputted continuous speech signal is performed by the segmentation processing module according to the predetermined parameters for processing the speech waveform and the information relevant to the inputted speech signal. Also, the waveform of the speech signal acquired from the segmentation process is displayed to the user by the waveform displaying module. Finally, the user is provided with the segmentation index by the segmentation result displaying module, the index is acquired from the segmentation process performed by the segmentation processing module.

In comparison to conventional speech waveform processing techniques, the speech waveform processing system and method proposed in the present invention are able to partition continuous speech waveform into a plurality of segments according to a predetermined speech parameter. Then, an index mechanism is established based on the segments produced by the segmentation process, such that any segments in the continuous speech waveform can be rapidly reached. Therefore, the drawback of the prior-art technique can be eliminated and the speech processing technique becomes more applicable.

### BRIEF DESCRIPTION OF THE DRAWINGS

The present invention can be more fully understood by reading the following detailed description of the preferred embodiments, with reference made to the accompanying drawings, wherein:

FIG. 1 is a block diagram showing basic construction of a speech waveform processing system according to the present invention;

FIG. 2 is a flowchart showing basic operation of a speech waveform processing method according to the present invention;

FIG. 3 is a picture of a computer screen showing predetermined parameters for processing speech waveforms in a speech waveform processing system according to the present invention;

FIG. 4 is a flowchart showing basic operation of a segmentation process performed by a segmentation processing module according to the present invention;

FIG. 5 is a picture of a computer screen showing a table of segmentation results of a continuous speech using a pop-up message provided by a segmentation processing module;

FIG. 6 is a picture of a computer screen showing a condition produced after confirming a segmentation result performed by a speech waveform processing system.

FIG. 7 is a picture of a computer screen showing operation of a segmentation process to partition a continuous speech by a segmentation processing module in combination with other software according to the present invention; and

FIG. 8 is a picture of a computer screen showing that a corresponding segment to be further played or processed can be directly reached by selecting from a segmentation index after partitioning continuous speech using a segmentation processing module according to the present invention.

### DETAILED DESCRIPTION OF THE EMBODIMENTS

The present invention is described in the following with specific embodiments, so that one skilled in the pertinent art can easily understand other advantages and effects of the present invention from the disclosure of the invention. The present invention may also be implemented and applied according to other embodiments, and the details may be modified based on different views and applications without departing from the spirit of the invention.

A speech waveform processing system is combined with a computer equipment to provide description for the present invention. However, please note that the invention is not only applicable to computer equipments. Instead, the present invention can be applied to any information equipments having a sound recognition function.

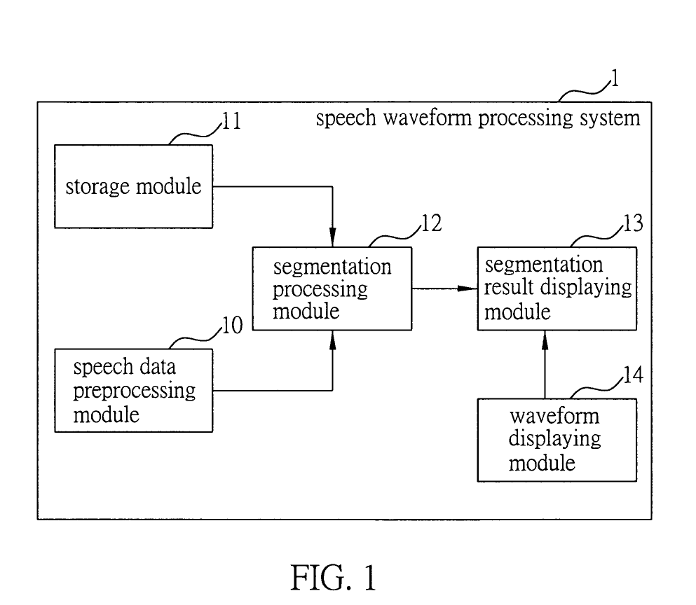

FIG. 1 is a block diagram showing basic construction of a speech waveform processing system according to the present invention. A speech waveform processing system 1 comprises a speech data preprocessing module 10, a storage module 11, a segmentation processing module 12, a segmentation result displaying module 13 and a waveform displaying module 14. In the present embodiment, a user can determine parameters for processing speech waveforms depending on personal requirements. These parameters at least comprise a threshold value of muting magnitude and a threshold value of muting interval. When a magnitude of a sound wave is smaller than the predetermined threshold value of muting magnitude, the state is determined as a muting state. When the time of the muting state exceeds the threshold value of muting interval, the state is determined as a speech quiescent state, and a segmentation process is performed on continuous speech according to the parameters.

The speech data preprocessing module 10 serves to read and preprocess inputted continuous speech signals and analyze the waveform of the inputted speech signal to record quiescent locations therein.

The storage module 11 serves to store the predetermined parameters for processing speech waveforms and information relevant to inputted speech signals. In the present embodiment, the predetermined parameters for processing speech waveforms at least comprise said threshold value of muting magnitude and the threshold value of muting interval predetermined by the user. The information relevant to the input speech signal at least comprises the quiescent locations in the speech waveform determined by the speech data preprocessing module 10.

The segmentation processing module 12 serves to perform a segmentation process on the inputted continuous speech signal according to the predetermined parameters for processing speech waveforms and the information relevant to inputted speech signal. The segmentation process is performed based on a segmentation algorithm.

The segmentation result displaying module 13 serves to provide the user with segmentation index acquired from the segmentation process performed by the segmentation processing module 12. In the present embodiment, the segmentation result displaying module 13 appears as a pop-up message and provides relevant information such as numbers of segments, initial positions and statistical information produced from the inputted speech after the segmentation process.

The waveform displaying module 14 serves to display waveform of the inputted continuous speech signal and waveform of the speech signal acquired after the segmentation process performed by the segmentation processing module 12. In the present embodiment, the waveform displaying module 14 serves to display original waveform of the inputted continuous speech signal before the segmentation process is performed for the inputted continuous speech signal by the segmentation processing module 12. Further, after the segmentation processing module 12 performs the segmentation process for the inputted continuous speech signal, waveform of the speech signal acquired from the segmentation process is displayed to the user by the waveform displaying module 14, which comprises a segmented waveform having segmentation lines.

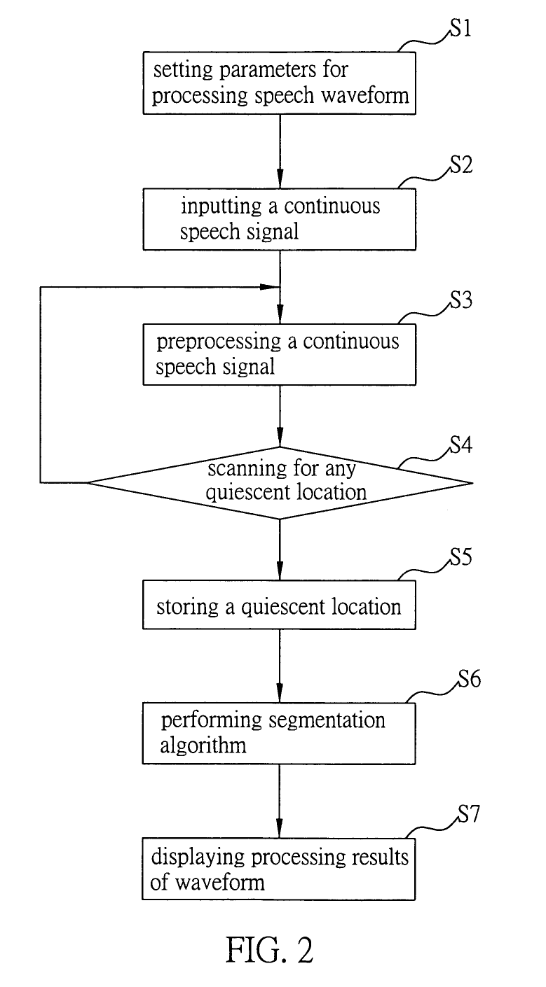

FIG. 2 is a flowchart showing basic operation of a speech waveform processing method according to the present invention.

In Step S1, parameter fields for setting parameters for processing speech waveforms are provided for the user, such that the user is able to select and set the parameters for processing speech waveforms using the parameter fields prior to perform Step S2.

In Step S2, a continuous speech signal is inputted into the speech waveform processing system 1. This continuous speech signal will be subject to the segmentation process, and it can be a portion of a speech inputted directly by the user or transcribed from any external equipments (such as a tape, CD or hard disk, etc.). Subsequently, Step S3 is performed.

In Step S3, the inputted continuous speech signal is read and preprocessed by the speech data preprocessing module 10. Also, the waveform of the continuous speech signal is displayed to the user by the waveform displaying module 14. Then, Step S4 is performed.

In Step S4, the inputted continuous speech signal is scanned by the speech waveform processing system 1, and quiescent locations in the continuous speech signal are determined by the parameters for processing speech waveforms preset using in said parameter fields. Then, Step S5 is performed.

In Step S5, the quiescent locations scanned by the speech waveform processing system 1 are stored by the storage module 11 prior to performing Step S6.

In Step S6, a segmentation algorithm to partition the continuous speech signal is performed by the segmentation processing module 12 according to the quiescent locations stored in the storage module 11, such that a segmentation list is produced prior to performing Step S7.

In Step S7, the segmentation list produced after said segmentation process is displayed by the segmentation result displaying module 13, and waveform of the continuous speech signal acquired after the segmentation process is displayed by the waveform displaying module 14. In other words, a segmented waveform with segmentation lines is displayed.

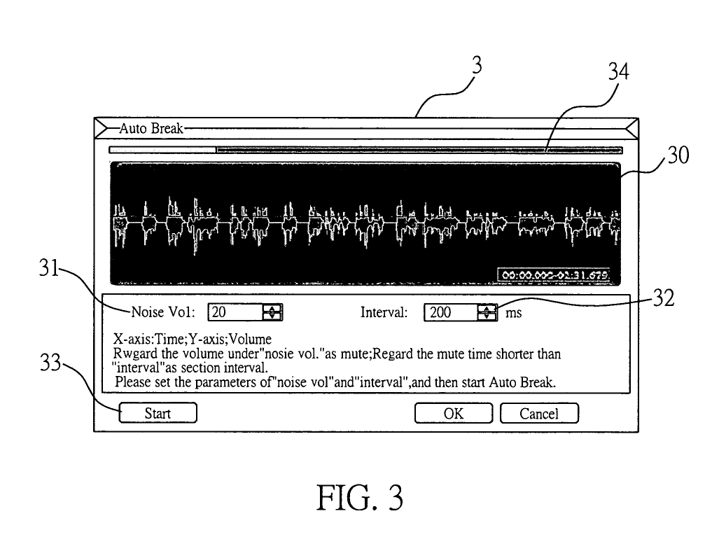

FIG. 3 is a picture of a computer screen for illustrating the operation of presetting parameters for processing speech waveforms in a speech waveform processing system according to the present invention. Referring to FIG. 3, a screen 3 comprises a waveform displaying section 30, a field 31 for setting a threshold value of muting magnitude, a field 32 for setting a threshold value of muting interval, a button 33 for running segmentation, a progress bar 34 and other relevant function sections. The waveform displaying section 30 uses 2-dimensional axes of coordinates to display original waveforms of the inputted speech. X-axis represents time whereas Y-axis represents the magnitude of the speech. For example, the user is able to set a magnitude threshold value for segmentation of the speech in the field 31 depending on personal requirements. When the magnitude of the speech is smaller than the threshold value, the system determines that no speech signal is present. Further, the user can also set a threshold value of muting interval in the field 32 for segmentation of the speech. When the muting interval is longer than the threshold value, the system determines the state as a quiescent state. The user can click on the button 33 using a mouse after completing the foregoing settings, so that a segmentation process can be performed on the speech waveform using the segmentation processing module 12. Additionally, the screen 3 also comprises the progress bar 34 to monitor and display the present progression.

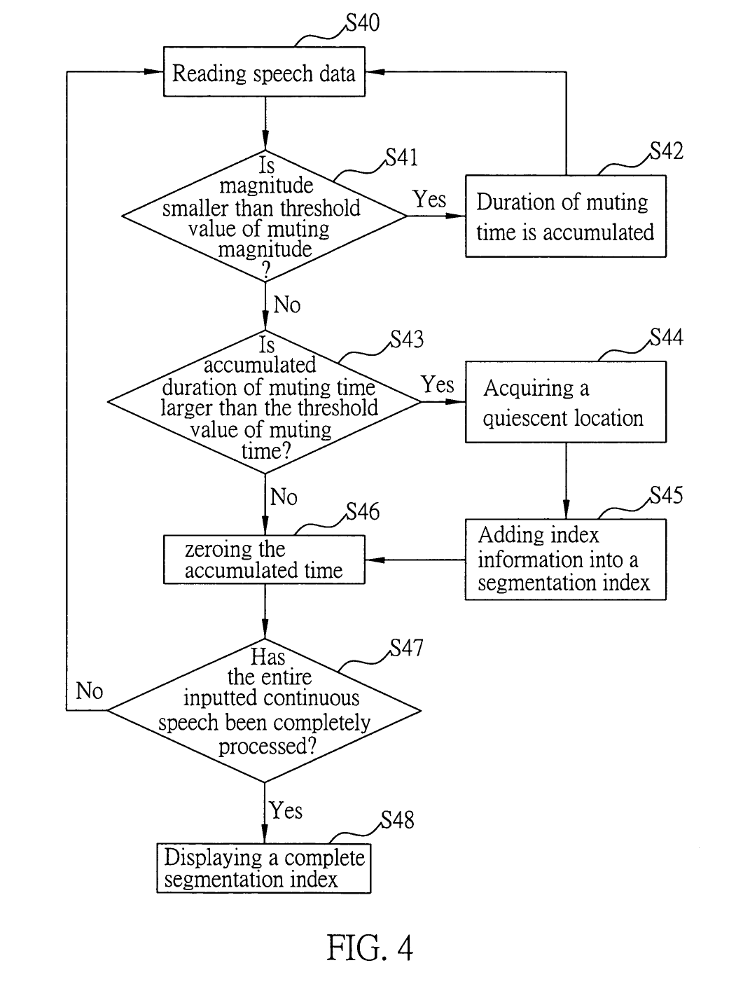

FIG. 4 is a flowchart showing basic operation of a segmentation process performed by the segmentation processing module 12 according to the present invention.

In Step S40, inputted continuous speech is read by the segmentation processing module 12, including magnitude of the continuous speech and other relevant information, prior to performing Step S41.

In Step S41, the segmentation processing module 12 serves to determine whether the speech magnitude is smaller than the preset threshold value of the muting magnitude. If yes, Step S42 is performed, else Step S43 is performed.

In Step S42, the segmentation processing module 12 serves to accumulate time duration in which the speech magnitude is smaller than the preset threshold value of the muting magnitude, and continuous speech data can continue to be read (Step S40) and steps from Step S40 to Step S42 can be repeatedly performed.

In Step S43, the segmentation processing module 12 serves to determine whether the accumulated duration of the muting time is larger than the preset threshold value of the muting interval. If yes, Step S44 is performed, else Step S46 is performed.

In Step S44, the information of the quiescent location in the speech waveform is acquired by the segmentation processing module 12. The information of the quiescent location can be quiescent middle time, quiescent initial time and duration, etc. Then, Step S45 is performed.

In Step S45, the segmentation processing module 12 serves to sequentially numbering the quiescent locations and subsequently place the numbers into a segmentation index table. Information such as segment numbers and quiescent locations is comprised in the segmentation index table. Step S46 is subsequently performed.

In Step S46, the segmentation processing module 12 serves to zero the accumulated muting time for accumulating the next muting time prior to perform Step S47.

In Step S47, the segmentation processing module 12 serves to determine whether the inputted continuous speech has been completely processed. If yes, Step S48 is performed, else Step S40 to Step S47 are repeatedly performed until the inputted continuous speech has been completely processed.

In Step S48, the segmentation processing module 12 serves to provide a table showing the complete segmentation results of the continuous speech using a pop-up message. The content being displayed comprises the total number of segments for the entire continuous speech, segmentation number for each segment, and durations of segments, etc.

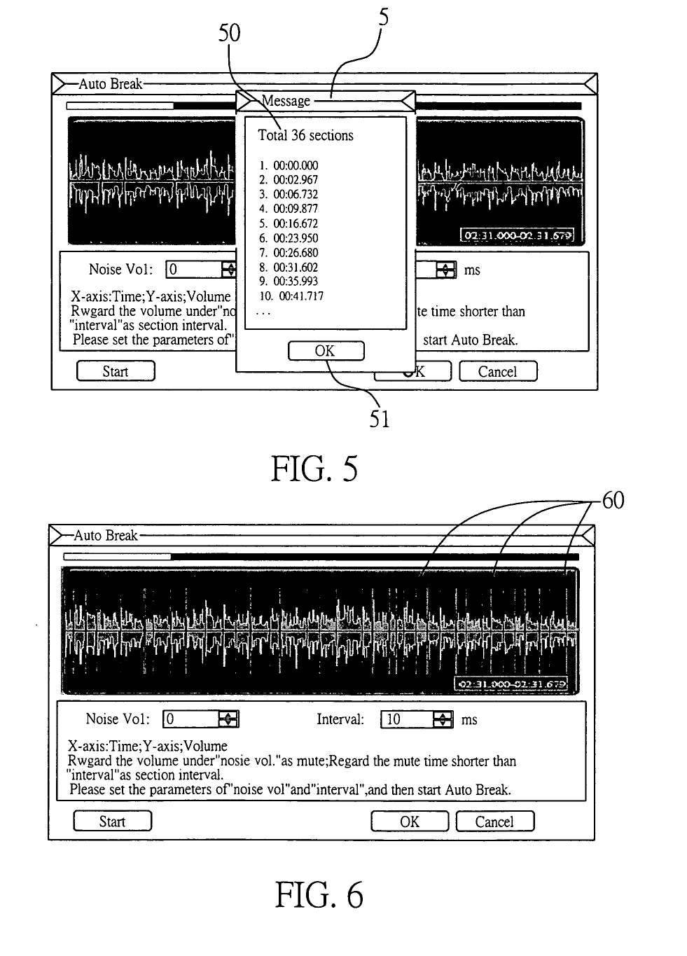

FIG. 5 is a picture of a computer screen showing a table of segmentation results of the continuous speech using a pop-up message provided by the segmentation processing module 12 as described in details in Step S48 above. Referring to FIG. 5, a pop-up message 5 is the table of segmentation results of the continuous speech. The displayed number 1 represents start of the speech, and duration of the speech section being determined as the displayed number 2 according to the preset parameters for processing speech waveforms is “00: 02.967”. The rest part of the message shows durations of other speech sections and is not further described. The pop-up message 5 comprises an indicator 50 for displaying the total number pf sections of the continuous speech produced after the segmentation process. In the present embodiment, the indicator 50 displays 36 sections of the continuous speech being performed with the segmentation process. Thus, the segmentation result of the continuous speech (not completely shown) can be clearly understood via the pop-up message 5. Furthermore, an “OK” button 51 can be clicked to confirm the segmentation result produced by the speech waveform processing system 1 and further link to a new frame shown in FIG. 6.

FIG. 6 is a frame showing a condition produced after clicking the OK button 51 shown in FIG. 5 to confirm the segmentation result produced by the speech waveform processing system 1. A series of segmentation lines 61 are used to represent corresponding segmented locations in a waveform displaying section 60.

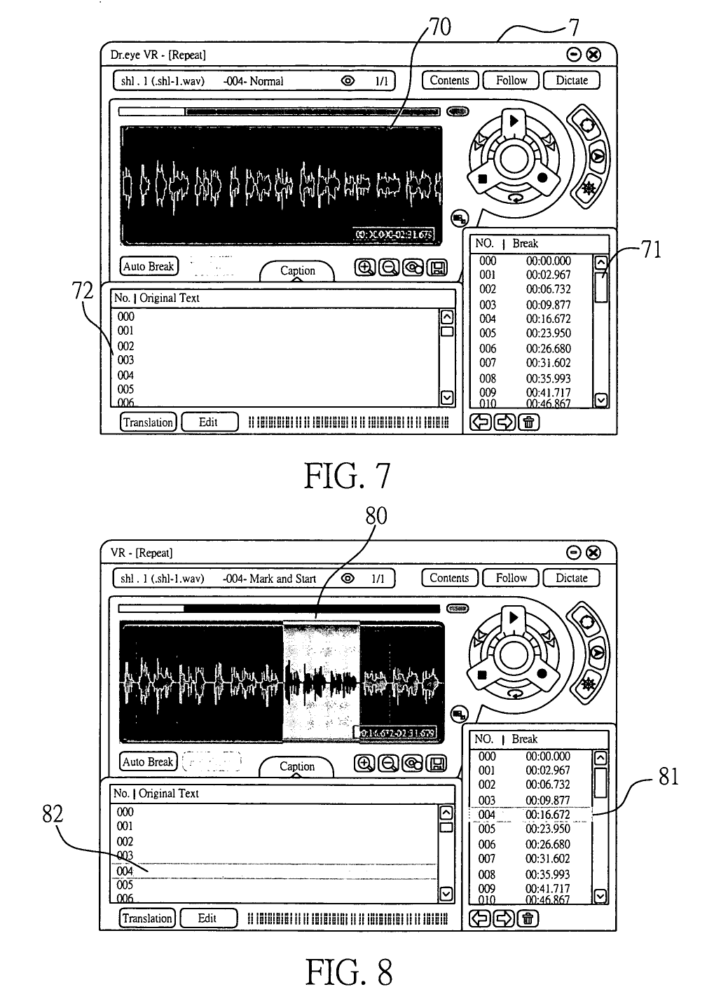

FIG. 7 is a picture of a computer screen showing operation of the segmentation process to partition the continuous speech by the segmentation processing module 12 in combination with other software according to the present invention. The software can be any application software which displays or edits sound files. Apart from a waveform displaying section 70, a screen 7 also comprises a table 71 for showing segmentation results, a table 72 for displaying speech information and a number of buttons for operating different functions.

FIG. 8 is a picture of a computer screen showing that a corresponding segment to be further played or processed can be directly reached by selecting from the segmentation index obtained after partitioning the continuous speech using the segmentation processing module 12 according to the present invention. The user can reach any corresponding position of the waveform by double clicking a section 80 of the waveform being partitioned by the segmentation lines in the waveform displaying section 70, or by double clicking any item 81 in the table 71 showing segmentation results or item 82 in the table 72 displaying speech information. Moreover, the user can also delete or further process the selected section of the waveform by clicking the buttons of operating different functions.

The speech waveform processing system and method proposed in the present invention are able to partition the continuous speech waveform into a plurality of segments according to the predetermined speech parameters. Then, the index is established based on the segments produced by the segmentation process, such that any segment in the continuous speech waveform can be rapidly reached. Therefore, the drawback of the prior-art technique can be eliminated and the speech processing technique becomes more applicable.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A speech waveform processing system for processing a continuous speech waveform according to predetermined parameters, comprising:
a segmentation parameter setting module for setting one or more parameters for processing the speech waveform;
a speech data preprocessing module for reading a signal of the continuous speech and preprocessing the speech signal;
a storage module for storing the one or more parameters for processing the speech waveform predetermined by the segmentation parameter setting module and information relevant to the speech signal;
a segmentation processing module for performing a segmentation process for the inputted continuous speech signal according to the one ore more parameters for processing the speech waveform predetermined by the segmentation parameter setting module and the inputted information relevant to the speech signal;
a segmentation result displaying module for providing a user with a segmentation index acquired from the segmentation process performed by the segmentation processing module; and
a waveform displaying module for displaying the original waveform of the inputted continuous speech signal and a waveform of a speech signal acquired from the segmentation process performed by the segmentation processing module.

2. The speech waveform processing system of claim 1, wherein the predetermined one or more parameters for processing speech waveforms comprises at least one of a threshold value of muting magnitude and a threshold value of muting interval.

3. The speech waveform processing system of claim 2, wherein if the magnitude of the speech waveform is smaller than the predetermined threshold value of muting magnitude, a muting state is determined by the speech waveform processing system.

4. The speech waveform processing system of claim 2, wherein if time of the muting state exceeds the predetermined threshold value of the muting interval, a speech quiescent state is determined by the speech waveform processing system.

5. The speech waveform processing system of claim 1, wherein the speech data preprocessing module serves to record any quiescent locations of the inputted speech waveform after analyzing the speech waveform.

6. The speech waveform processing system of claim 1, wherein the segmentation processing module serves to perform a segmentation process on the continuous speech signal based on a segmentation algorithm.

7. The speech waveform processing system of claim 1, wherein the segmentation result displaying module serves to display the speech waveform with segmentation marks and the segmentation index produced after the segmentation process has been performed.

8. A speech waveform processing method for processing a continuous speech waveform according to one or more parameters predetermined in a speech waveform processing system, the method comprising the following steps:
1) predetermining one or more parameters for processing the speech waveform by the speech waveform processing system;
2) reading and preprocessing the inputted continuous speech signal by the speech waveform processing system, and displaying a waveform of the inputted continuous speech signal by a waveform displaying module in the speech waveform processing system;
3) storing the predetermined one or more parameters for processing the speech waveform and information relevant to the inputted speech signal by the speech waveform processing system;
4) performing a segmentation process on the inputted continuous speech signal by the speech waveform processing system according to the predetermined one or more parameters for processing the speech waveform and the inputted information relevant to the speech signal, and displaying a waveform of a speech signal acquired from the segmentation process by the waveform displaying module; and
5) providing a user with a segmentation index produced after the segmentation process performed by the speech waveform processing system.

9. The speech waveform processing method of claim 8, wherein the one or more parameters predetermined in the speech waveform processing system comprises at least one of a threshold value of muting magnitude and a threshold value of muting interval.

10. The speech waveform processing method of claim 9, wherein if the magnitude of the speech waveform is smaller than the predetermined threshold value of muting magnitude, a muting state is determined by the speech waveform processing system.

11. The speech waveform processing method of claim 9, wherein if time of the muting state exceeds the predetermined threshold value of muting interval, a speech quiescent state is determined by the speech waveform processing system.

12. The speech waveform processing method of claim 8, wherein the speech waveform processing system serves to record any quiescent locations of the inputted speech waveform after analyzing the speech waveform.

13. The speech waveform processing method of claim 8, wherein the speech waveform processing system serves to perform a segmentation process on the continuous speech signal based on a segmentation algorithm.

14. The speech waveform processing method of claim 8, wherein the speech waveform processing system serves to display the speech waveform with segmentation lines and the segmentation index produced after the segmentation process has been performed.
